(19) United States
(12) Patent Application Publication
(10) Pub. No.: US 2026/0264749 A1
(43) Pub. Date: Sep. 10, 2026

(54) TRAILER JACKKNIFE PREVENTION

(71) Applicant: GM GLOBAL TECHNOLOGY OPERATIONS LLC, DETROIT, MI (US)

(72) Inventors: Utkarsh Saini, Pickering (CA); Zachary Thomas Kroeze, Toronto (CA); Jackson Barry McGrory, Toronto (CA)

(21) Appl. No.: 19/072,335

(22) Filed: Mar. 6, 2025

(51) Int. Cl. B62D 6/00; B60D 1/30

(52) U.S. Cl. CPC B62D 6/003; B60D 1/30

(57) ABSTRACT

A system for monitoring a vehicle-trailer system includes a processing device configured to receive image data from a detection device, the image data including an image of a connection between a vehicle and a trailer being towed by the vehicle. The processing device is configured to estimate a maximum articulation angle between the vehicle and the trailer, analyze the image data to estimate a current articulation angle, determine a difference between the current articulation angle and the maximum articulation angle, and based on the current articulation angle being greater than or equal to the maximum articulation angle, or based on the current articulation angle being within a range of the maximum articulation angle, control the vehicle to avoid a jackknife condition.

### INTRODUCTION

The subject disclosure relates to the art of vehicle control. More particularly, the subject disclosure relates to systems and methods for controlling a vehicle towing a trailer to prevent undesirable articulation.

Modern vehicles are often utilized to tow trailers of various kinds. Such vehicles can be equipped with trailer hitches, which are commonly ball coupler type hitches. When towing a trailer, there is a possibility that an articulation angle between a leading vehicle and a trailer becomes too small. For vehicles having tight turning radiuses (e.g., vehicles equipped with rear wheel steering capabilities), this possibility becomes exacerbated. It is desirable to provide improved systems and methods for monitoring tow vehicles and/or articulated vehicles to maintain desired articulation angles and avoid jackknife or other undesirable conditions.

### SUMMARY

In one exemplary embodiment, a system for monitoring a vehicle-trailer system includes a processing device configured to receive image data from a detection device, the image data including an image of a connection between a vehicle and a trailer being towed by the vehicle. The processing device is configured to estimate a maximum articulation angle between the vehicle and the trailer, analyze the image data to estimate a current articulation angle, determine a difference between the current articulation angle and the maximum articulation angle, and based on the current articulation angle being greater than or equal to the maximum articulation angle, or based on the current articulation angle being within a range of the maximum articulation angle, control the vehicle to avoid a jackknife condition.

In addition to one or more of the features described herein, the vehicle includes a rear steering system, and the vehicle is controlled by performing at least one of turning off the rear steering system, and controlling the rear steering system to adjust a rear steering angle.

In addition to one or more of the features described herein, the processing device is further configured to estimate a maximum rear steering angle based on the current articulation angle and the maximum articulation angle.

In addition to one or more of the features described herein, the detection device includes a camera and the image data includes an optical image of at least a part of the connection.

In addition to one or more of the features described herein, the processing device is configured to estimate the maximum articulation angle by acquiring a virtual template of the connection, estimating a dimension of the virtual template based on the image data, and rotating a component of the virtual template to estimate the maximum articulation angle.

In addition to one or more of the features described herein, the processing device is configured to estimate the maximum articulation angle based on one or more keypoints identified in the image data.

In addition to one or more of the features described herein, the maximum articulation angle is estimated by acquiring a trailer profile and constructing a virtual template of the connection, and rotating a component of the virtual template.

In addition to one or more of the features described herein, the processing device is configured to predict an imminent jackknife condition, the predicting including analyzing the image data to locate a rear portion of the vehicle, and determining a proximity between the trailer and the rear portion.

In another exemplary embodiment, a method of monitoring a vehicle-trailer system includes receiving image data from a detection device, the image data including an image of a connection between a vehicle and a trailer being towed by the vehicle. The method also includes estimating a maximum articulation angle between the vehicle and the trailer, analyzing the image data to estimate a current articulation angle, determining a difference between the current articulation angle and the maximum articulation angle, and based on the current articulation angle being greater than or equal to the maximum articulation angle, or based on the current articulation angle being within a range of the maximum articulation angle, controlling the vehicle to avoid a jackknife condition.

In addition to one or more of the features described herein, the vehicle includes a rear steering system, and controlling the vehicle includes at least one of turning off the rear steering system, and controlling the rear steering system to adjust a rear steering angle.

In addition to one or more of the features described herein, the method further includes estimating a maximum rear steering angle based on the current articulation angle and the maximum articulation angle.

In addition to one or more of the features described herein, the detection device includes a camera and the image data includes an optical image of at least a part the connection, and estimating the maximum articulation angle includes acquiring a virtual template of the connection, estimating a dimension of the virtual template based on the image data, and rotating a component of the virtual template.

In addition to one or more of the features described herein, estimating the dimension is based on one or more key points identified in the image data.

In addition to one or more of the features described herein, the maximum articulation angle is estimated by acquiring a trailer profile and constructing a virtual template of the connection, and rotating a component of the virtual template.

In addition to one or more of the features described herein, the method further includes predicting an imminent jackknife condition, the predicting including analyzing the image data to locate a rear portion of the vehicle, and determining a proximity between the trailer and the rear portion.

In yet another exemplary embodiment, a vehicle system includes a detection device configured to monitor a connection between a vehicle and a trailer being towed by the vehicle, and generate data related to the connection, and a processing device configured to receive image data from a detection device, the image data including an image of the connection. The processing device is configured to estimate a maximum articulation angle between the vehicle and the trailer, analyze the image data to estimate a current articulation angle, determine a difference between the current articulation angle and the maximum articulation angle, and based on the current articulation angle being greater than or equal to the maximum articulation angle, or based on the maximum articulation angle being within a range of the maximum articulation angle, control the vehicle to avoid a jackknife condition.

In addition to one or more of the features described herein, the vehicle includes a rear steering system, and the vehicle is controlled by performing at least one of: turning off the rear steering system, and controlling the rear steering system to adjust a rear steering angle.

In addition to one or more of the features described herein, the processing device is further configured to estimate a maximum rear steering angle based on the current articulation angle and the maximum articulation angle.

In addition to one or more of the features described herein, the detection device includes a camera and the image data includes an optical image of at least a part the connection, and the processing device is configured to estimate the maximum articulation angle by acquiring a virtual template of the connection, estimating a dimension of the virtual template based on the image data, and rotating a component of the virtual template.

In addition to one or more of the features described herein, the maximum articulation angle is estimated by acquiring a trailer profile and constructing a virtual template of the connection, and rotating a component of the virtual template.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic top view of a motor vehicle, in accordance with an exemplary embodiment;

FIG. 2 is a side view of a vehicle-trailer system, in accordance with an exemplary embodiment;

FIG. 3 depicts examples of an articulation angle between a vehicle and a trailer;

FIG. 4 is a flow diagram depicting aspects of a method of monitoring a vehicle-trailer system, in accordance with an exemplary embodiment;

FIG. 5 depicts a template representing portions of a vehicle and a trailer, in accordance with an exemplary embodiment;

FIGS. 6A and 6B depict models of a vehicle and a trailer, in accordance with an exemplary embodiment;

FIG. 7 depicts a model of a vehicle-trailer system, which includes keypoints used to calculate a maximum articulation angle, in accordance with an exemplary embodiment;

FIG. 8 is an image of a connection between a vehicle and a trailer, in accordance with an exemplary embodiment;

FIG. 9 is a flow diagram depicting aspects of a method of calculating a maximum articulation angle for a vehicle-trailer system, in accordance with an exemplary embodiment;

FIG. 10 is an image of a connection between a vehicle and a trailer, and representations of keypoints used to calculate a maximum articulation angle, in accordance with an exemplary embodiment;

FIG. 11 depicts an example of a limit curve for a rear steering system, in accordance with an exemplary embodiment; and

FIG. 12 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for monitoring and/or control of a vehicle-trailer system, for prevention of jackknifes and other undesirable conditions. An embodiment of a monitoring system includes a processing device configured to receive images of a connection between a vehicle and a trailer. The monitoring system determines a maximum articulation angle (i.e., an articulation angle beyond which a jackknife is imminent or likely).

The monitoring system may continuously or periodically monitor the connection and collect images during travel, calculate a current articulation angle, and compare the current articulation angle to the maximum articulation angle. If the current articulation angle exceeds that maximum, or is within some range of the maximum, the vehicle may be controlled (e.g. steered, slowed, etc.) to reduce the articulation angle and thereby prevent jackknife conditions from arising.

The vehicle may be equipped with a rear steering system that is used in coordination with front steering to provide for a tighter turning radius. In an embodiment, the monitoring system (or other processor or system) can limit, disable or otherwise control the rear steering system in response to an excessive articulation angle. In an embodiment, the monitoring system is configured to calculate a maximum allowed steering angle and/or rear wheel angle based on the maximum articulation angle.

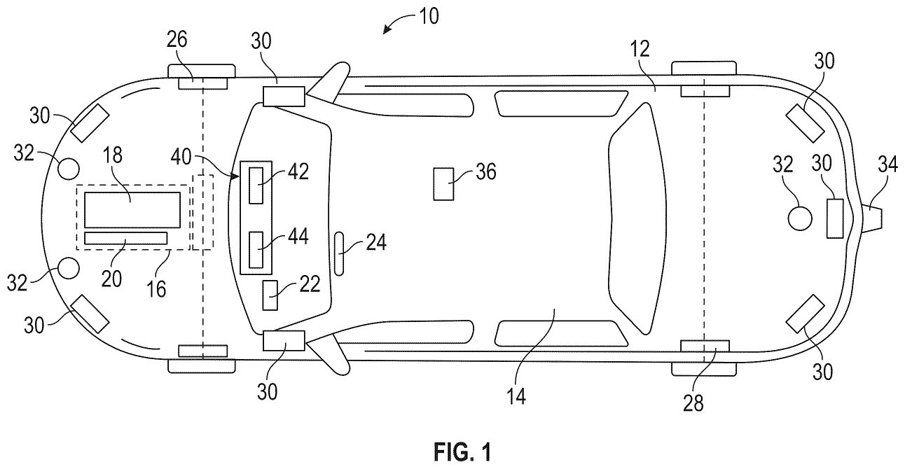

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion systems 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor 20. The vehicle 10 may be a fully electric vehicle having one or more electric motors.

The vehicle 10 also includes various control devices for controlling aspects of vehicle operation. Such devices include, for example, an accelerator 22, a steering wheel 24, front brakes 26 and rear brakes 28.

The vehicle also includes a perception system and a vehicle control system, aspects of which may be incorporated in or connected to the vehicle 10. The perception system receives perception data (e.g., images) from various sensors. In an embodiment, the sensors include one or more optical cameras 30 configured to take images, which may be still images and/or video images. Additional devices or sensors may be included, such as one or more radar assemblies 32 included in the vehicle 10. The perception system is not so limited and may include other types of sensors, such as lidar, infrared cameras, microphones, and others.

There may be any number of cameras 30 and/or radar assemblies 32 at any desired location(s). For example, as shown, the perception system includes forward and rear facing cameras 30. At least one rear facing camera 30 may be disposed relative to a tow hitch 34 or other connection system that allows for towing a trailer.

Control devices and actuators, and other components such as the perception system, are controllable via one or more control units, collectively represented by a vehicle controller 36. The vehicle controller 36 includes processing components for controlling aspects of vehicle operation, such as control of propulsion, braking and steering, as well as functions such as monitoring a trailer.

The vehicle controller 36 may be configured to control the vehicle 10 in accordance with various forms of automated control. In an embodiment, the vehicle controller 36 is configured for one or more automation levels, such as Level 1, Level 2 and/or Level 3 automation. Level 1 automation includes driver assistance. Level 2 automation allows for vehicle control of steering and acceleration, with the driver monitoring and ready to take control at any time. In Level 3 automation (conditional automation), a vehicle can monitor the environment and automatically control the operation.

The vehicle controller 36 may control other vehicle systems. For example, the vehicle 10 is equipped with an active rear steering (ARS) system. The ARS system provides for automatically controlling a rear axle in the same or opposite phase as a front axle, in order to significantly increase the vehicle's turning radius. The ARS system may be activated and deactivated as desired.

The vehicle 10, perception system, the vehicle controller 36 and other vehicle systems are included in, or are connected to, an on-board computer system 40 that includes one or more processing devices 42 and a user interface 44. The user interface 44 may include a touchscreen, a speech recognition system and/or various buttons for allowing a user to interact with features of the vehicle. The user interface 44 may be configured to interact with a user or driver via visual communications (e.g., text and/or graphical displays), tactile communications or alerts (e.g., vibration), and/or audible communications.

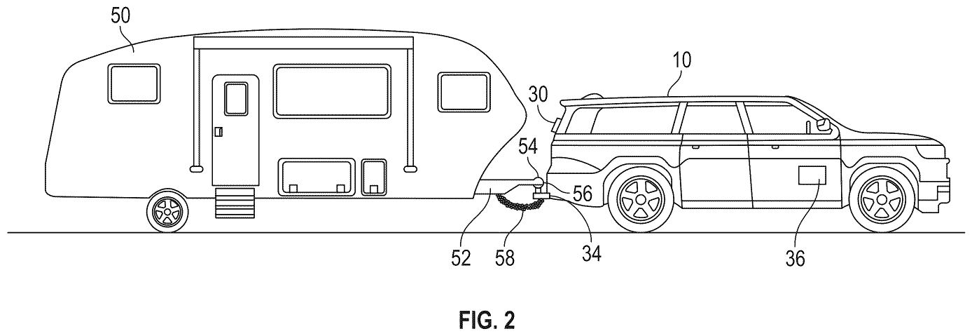

FIG. 2 shows an embodiment of the vehicle 10 as connected to a trailer 50. The vehicle 10 is connected to the trailer 50 by a suitable connection, such as the tow hitch 34, a fifth-wheel coupling, or another suitable coupling system. For example, the trailer 50 includes a frame portion or tongue 52 that includes a coupler 54, such as a ball coupler. The vehicle tow hitch 34 has a ball 56 configured to be connected to the coupler 16. A device such as a chain 58 (or break away cable) may be connected to the frame 52 and the tow hitch 34 to maintain a connection in case the coupler 54 is disengaged from the ball 56.

A processing device, such as the vehicle controller 36 and/or the processor 42, is configured to monitor a trailer and connection system, and detect an undesirable condition. An undesirable condition may be any condition that could cause or potentially lead to a collision between a vehicle and a trailer, such as the vehicle 10 and the trailer 50. In an embodiment, the undesirable condition is a jackknife condition, in which an angle between a vehicle and a trailer is large enough to cause a jackknife. In vehicles having rear steering capability, a jackknife in the forward direction can occur, depending on trailer geometry and turn radius.

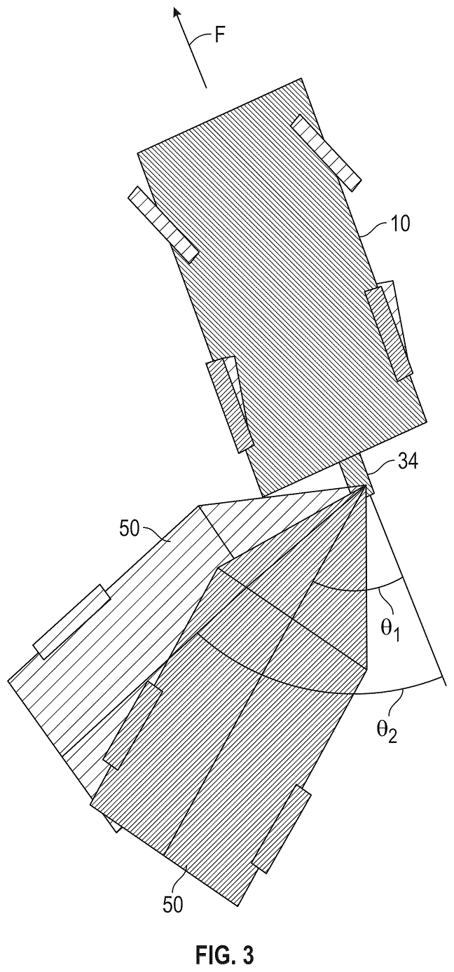

FIG. 3 depicts examples of articulation angles. In these example, the vehicle 10 is traveling in a forward direction F, and the trailer 50 defines an articulation angle θ (also referred to as a trailer articulation angle or TAA). The vehicle 10 initiates a turn and has a tight turning radius, causing the TAA to increase (angle θ1). The tight turning radius may result in an excessive TAA (angle θ2) that could result in a jackknife (a forward jackknife in this example).

Embodiments described herein may be used to define a maximum TAA, and control the vehicle 10 based on a comparison between a maximum TAA and a current TAA to avoid an excessive TAA that could result in a jackknife. By controlling rear steering and/or other operating parameter or parameters (e.g., braking, acceleration, rear steering, etc.), the vehicle 10 is able to compensate for increases in the articulation angle and prevent a jackknife condition.

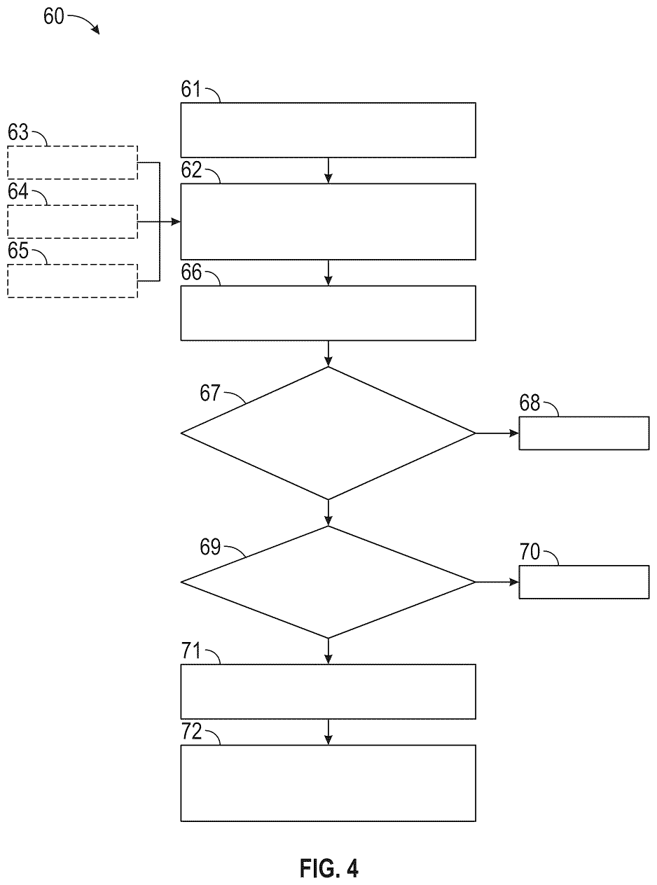

FIG. 4 depicts an embodiment of a method 60 of monitoring a vehicle-trailer system. The method 60 is discussed in conjunction with blocks 61-72. The method 60 is not limited to the number or order of steps therein, as some steps represented by blocks 61-72 may be performed in a different order than that described below, or fewer than all of the steps may be performed.

The method 60 is discussed in conjunction with the vehicle 10 of FIG. 1 and the trailer 50 of FIG. 2, but is not so limited, as the method 60 may be used with any vehicle or trailer or machine having articulated connections (e.g., articulated vehicles such as tractor-trailer trucks and articulated buses). It is noted that the term “trailer” is not intended to limit the embodiments to any particular type of trailer.

At block 61, a vehicle profile is acquired. The vehicle profile includes information on a towing vehicle (e.g., the vehicle 10), such as wheelbase, length and width.

At block 62, a maximum TAA is calculated. The maximum TAA may be calculated during vehicle operation, prior to operation or at any other suitable time. For example, during vehicle operation, the maximum TAA is calculated based on a trailer profile received at block 63, a trailer image received at block 64 and/or user input received at block 65.

The trailer image may be an image of at least a portion of the trailer 50 connected to the vehicle 10, as well as a portion of a connection between the vehicle 10 and the trailer 50. For example, a rear facing camera 30 is positioned to capture images of the vehicle bumper and/or hitch 34, the coupler 54 and the frame portion 52.

A processing device monitors the connection by continuously or periodically taking images of the connection, determining a current TAA, and comparing the current TAA to the maximum TAA. Based on a difference therebetween, the processing device determines whether a jackknife could or is predicted to occur. If so, the processing device may control the vehicle 10 (e.g., by reducing speed, steering the vehicle, etc.), direct another vehicle system to control the vehicle, or provide an alert and/or information to a user or driver.

If the vehicle 10 has rear steering capability (e.g., includes an ARS system), the method 60 further includes stages represented by blocks 66-72.

At block 66, a maximum rear wheel angle (RWAₘₐₓ) is calculated. The maximum rear wheel angle is calculated based on the vehicle profile, the trailer profile and the maximum TAA as discussed further herein.

At block 67, the processing device monitors the connection during travel, and continuously or periodically determines whether a jackknife is possible or likely (i.e., identifies a potential jackknife condition). A potential jackknife condition may be identified by comparing a current TAA (e.g., derived from a camera image) to the maximum TAA. If the current TAA reaches, exceeds or approaches (i.e., is within a selected range of) the maximum TAA, a potential jackknife condition is identified. If no potential jackknife condition is identified, monitoring continues without controlling or changing vehicle operation (block 68).

At block 69, if a potential jackknife condition is identified, the processing device determines whether the vehicle 10 has full control of the ARS system. If not, the ARS system is disabled or turned off at block 70.

At block 71, if the vehicle 10 has full control of the ARS system, rear steering is limited based on an applied front steering angle.

At block 72, monitoring continues and the maximum rear wheel angle RWAₘₐₓ is calculated. The maximum rear steering angle may be calculated based on a proximity of a rear bumper or other rear portion of the vehicle 10 to the trailer 50 (as determined via image data).

The maximum TAA may be calculated in a number of ways. In an embodiment, a vehicle template is acquired or generated. The vehicle template is a representation (e.g., line drawing, CAD model, etc.) of components of a vehicle-trailer connection, such as part of the trailer frame portion 52 and the coupler 54, and part of the trailer hitch 34 and/or a rear bumper. The maximum TAA may be calculated by rotating a component of the template, and finding the maximum rotation angle that can be applied without any edges of the component intersecting another component.

FIG. 5 depicts an example of a connection template 80, which was generated using image data and/or other information (e.g., vehicle and trailer profiles) related to a connection between the trailer 50 and the vehicle 10. For example, a bird's eye image of the connection was taken and transformed into a simplified line drawing or other graphical element. The template 80 includes a representation 82 of part of the trailer frame portion 52 and the coupler 54, and a representation of part of the vehicle 10 (a vehicle boundary 84 representing an edge of the vehicle's rear bumper). To determine the maximum TAA, the element 82 is rotated in a direction shown by arrow 86. The rotation is about a pivot point corresponding to the hitch 34 (e.g., corresponding to the ball 56) until one or more edges of the representation 82 intersect(s) the boundary 84. The angle of this rotation is correlated with the maximum TAA.

In an embodiment, a template or model of the vehicle-trailer system (or portion thereof) is generated, and one or more locations of interest are determined. Such locations are referred to as “keypoints.” The locations include points where the trailer and vehicle would be expected to meet or intersect if a jackknife occurs.

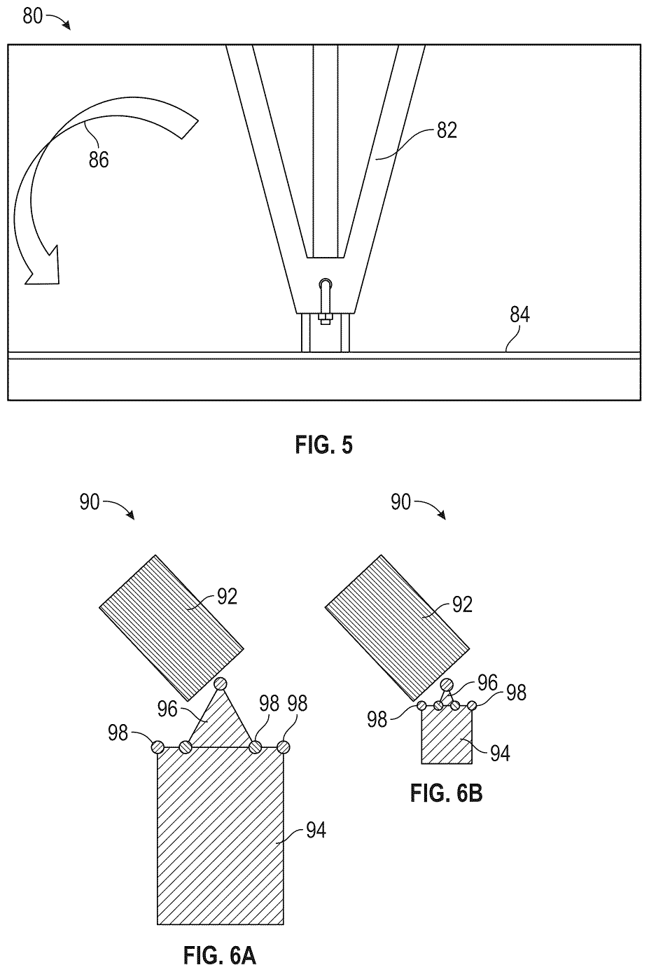

FIGS. 6A and 6B show examples of a vehicle-trailer model 90 for two different trailers connected to a vehicle. The model 90 includes a model element representing a vehicle (element 92), a trailer element 94 representing a body of a trailer, and a triangular element 96 representing a trailer tongue and coupler. Keypoints 98 are selected, which are selected based on dimensions of the system and are used to calculate a maximum TAA. For example, the element 92 may be rotated and edge detection used to select the keypoints 98. Additionally, or alternatively, a user may be prompted to input one or more keypoints 98. The trailer of FIG. 6A is significantly larger than the trailer of FIG. 6B; as such, the maximum TAA will be different.

In an embodiment, dimensions of a trailer (body and/or frame-coupler) are used to calculate a conservative version of the maximum TAA (referred to as a maximum jackknife angle). Dimensions such as overall trailer width, tongue length (distance from a ball or other hitch connector to a front wall of the trailer), and hitch length are used to calculate the maximum jackknife angle and/or the maximum TAA.

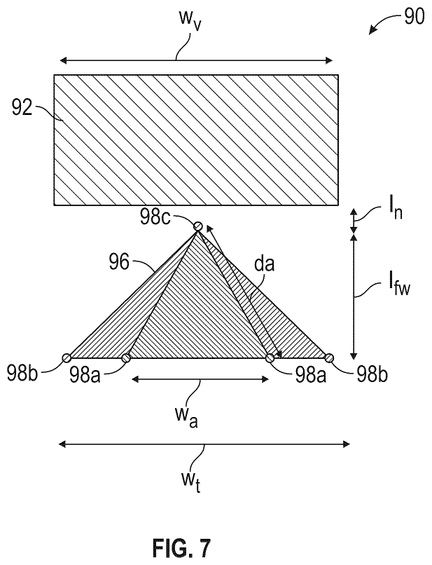

Referring to FIG. 7, in an embodiment, the maximum TAA is calculated using a trailer profile in conjunction with selected keypoints. FIG. 7 shows a portion of the model 90 and various keypoints 98.

As shown, the model 90 has various dimensions defined by the geometry of a trailer and selected keypoints 98. Keypoints 98a are located where a frame portion or tongue of the trailer (represented by the triangular element 96) intersects the trailer body (element 94 of FIG. 6A or 6B). A distance between the keypoints 98a is referred to as a frame width wₐ.

Keypoints 98b represent edges of the trailer body, and define a trailer width wₜ. A vehicle width is denoted as wᵥ. A distance from a keypoint 98a to a keypoint 98c is a length of a side of the frame portion, and is referred to as a length dₐ. The length dₐ may be calculated as follows:

$${d}_{a} = \sqrt{{( \frac{{w}_{a}}{2} )}^{2}} + {( {l}_{fw} )}^{2} ,$$

where l_{fw} is a length of the tongue.

If dₐ is less than wᵥ/2, the maximum TAA (also referred to as θₘₐₓ) is calculated based on:

$${θ}_{max} = 90 - {tan}^{- 1} ( \frac{{w}_{t}}{2 {l}_{fw}} ) ,$$

$$or$$

$${θ}_{max} = 90 - {tan}^{- 1} ( \frac{{w}_{t}}{2 {l}_{fw}} ) + {tan}^{- 1} ( \frac{2 {l}_{h}}{{w}_{v}} ) .$$

If dₐ is greater than or equal to wᵥ/2, θₘₐₓ is calculated based on:

$${θ}_{max} = 90 - {tan}^{- 1} ( \frac{{w}_{a}}{2 {l}_{fw}} ) ,$$

$$Or$$

$${θ}_{max} = 90 - {tan}^{- 1} ( \frac{{w}_{a}}{2 {l}_{fw}} ) + {tan}^{- 1} ( \frac{2 {l}_{h}}{{w}_{v}} ) .$$

In an embodiment, the vehicle 10 and/or the monitoring system is configured to predict an imminent jackknife condition. Trailer detection may be used by generating a real time representation of a portion of a trailer including connection components (e.g., frame portion and coupler). For example, an image from a rear camera is converted to a line-based representation in real time, and the location of pixels is monitored to determine whether the connection components intersect the vehicle 10 or are within a selected distance from the vehicle 10.

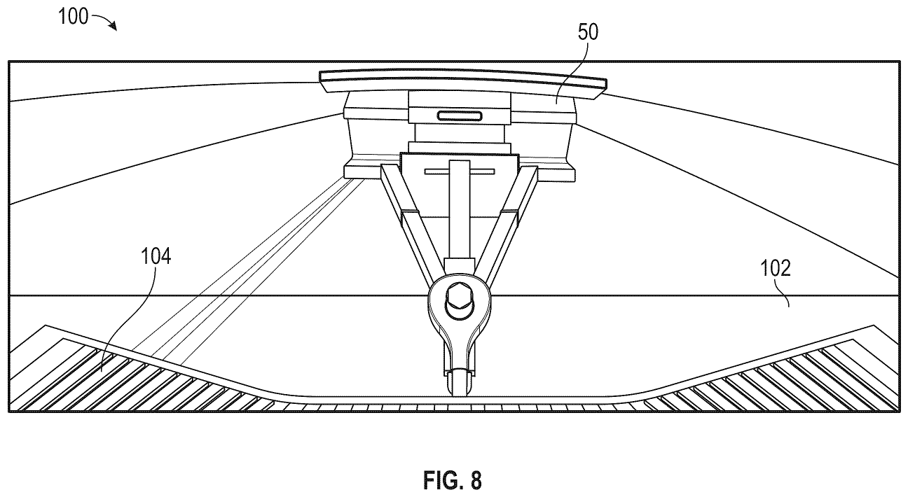

FIG. 8 depicts an example of an image 100 from a rear camera 30, and illustrates aspects of an embodiment of predicting an imminent jackknife condition. This prediction process is based on an assumption that the vehicle bumper (or other rear portion of the vehicle 10) will remain in a known pre-defined area of each image from the rear camera 30, and that the bumper is static relative to the camera 30 when the vehicle 10 is moving.

The image 100 is acquired during travel. A static region 102 of the image 100 is selected, which includes a portion of a rear bumper 104 of the vehicle 10. As images are acquired, the processing device searches the static region 102 and identifies pixel changes within the static region (i.e., changes in pixels as compared to a previous image). Changes in pixels may be associated with part of the trailer 50 entering the region, which may be indicative of an imminent jackknife.

As noted above, calculation of the maximum TAA may be performed using one or more keypoints that are determined via user input. This allows for a user's knowledge and experience to enhance the maximum TAA.

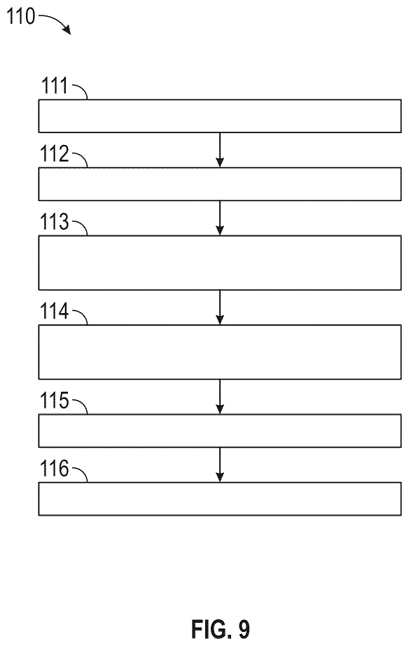

FIG. 9 depicts an embodiment of a method 110 of monitoring a vehicle-trailer system. The method 110 is discussed in conjunction with blocks 111-116. The method 110 is not limited to the number or order of steps therein, as some steps represented by blocks 111-116 may be performed in a different order than that described below, or fewer than all of the steps may be performed.

The method 110 is discussed in conjunction with the vehicle 10 of FIG. 1 and the trailer 50 of FIG. 2, but is not so limited, as the method 110 may be used with any vehicle or machine having articulated connections.

At block 111, an image is acquired from a rear view camera (e.g., a camera 30). At block 112, the rear view image is converted to a bird's eye view image.

At block 113, using the image, keypoint locations are determined (“required” keypoints) and applied to the image. At block 114, the image and the required keypoints are presented to a user, and the user is given an opportunity to adjust the location of any of the required keypoints, to ensure accuracy of keypoint placement. The user may add additional keypoints (“optional” keypoints).

At block 115, the location of the required and optional keypoints are determined and applied to a model (e.g., the model 90). At block 116, a maximum TAA is calculated as discussed herein.

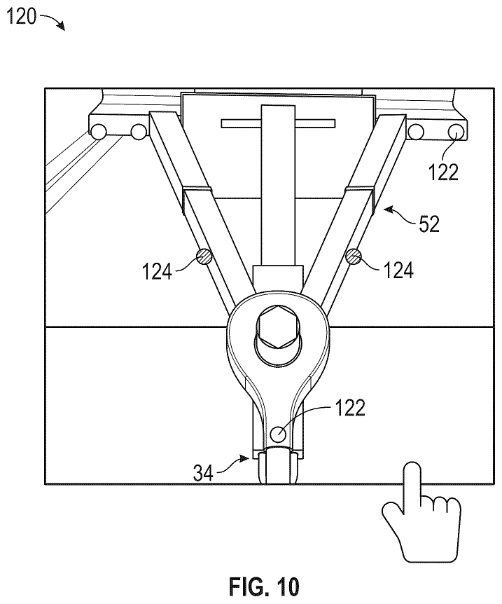

FIG. 10 shows an example of an image 120 that was acquired from a rear view camera and converted to a birds eye view image. As shown, a number of required keypoints 122 are located on the image 120, at edges of the trailer body and the frame portion, as well as a coupler location. In this example, a user has selected keypoints 124. The selected keypoints 124 (optional keypoints) in this example may be used to define the frame width wₐ, which affects the maximum TAA.

As noted above, if rear steering is available, the maximum TAA may be converted to a rear steering limit based on a maximum rear wheel angle RrRWAₘₐₓ. In an example, RrRWAₘₐₓ is calculated using a system of equations based on vehicle and trailer geometries. RrRWAₘₐₓ may be continuously or periodically updated during vehicle operation.

The following system of equations is used to calculate the maximum rear steering angle using the maximum TAA, which is represented in the equations as a maximum hitch articulation angle ψₕ, and a front steering angle:

$${R}_{t} ( sin {ψ}_{h} ) = {l}_{t} ( cos {ψ}_{h} ) + {l}_{h} + {x}_{c} ,$$

where:

$${R}_{t} = \sqrt{{R}_{h}^{2} - {l}_{t}^{2}} ,$$

$${R}_{h} = \sqrt{{l}_{h}^{2} + {R}_{r}^{2} - 2 {l}_{h} {R}_{r} sin {δ}_{r}} ,$$

$${R}_{r} = \frac{L cos {δ}_{f}}{sin ( {δ}_{f} - {δ}_{r}} , and$$

$${x}_{c} = - {R}_{r} sin {δ}_{r} .$$

In the above equations, L is a vehicle wheelbase, and δ_{f} and δᵣ are the front and rear steering angle, respectively. lₕ is a distance from a vehicle rear axle to a trailer hitch, and lₜ is a distance from the rear axle to a trailer frame portion (tongue)

The following is an example of a calculation of maximum rear steering angle RrRWAₘₐₓ. In this example, the vehicle 10 and the trailer 50 are moving generally straight, or stationary (i.e., are in a stable position). Profiles of the vehicle 10 and the trailer 50 are collected, and an image is taken when the vehicle and trailer are in the stable position. The profiles and the image are used to generate the model of FIG. 6A.

A value of the maximum TAA (TAAₘₐₓ) is calculated as 60 degrees, and based on vehicle and trailer geometry, a maximum rear steering angle of −8 degrees is calculated. This value is stored as an ARS limit. As the vehicle 10 travels, the connection is monitored by taking additional images, and the RrRWAₘₐₓ may be updated. In this example, RrRWAₘₐₓ is updated to −6 degrees.

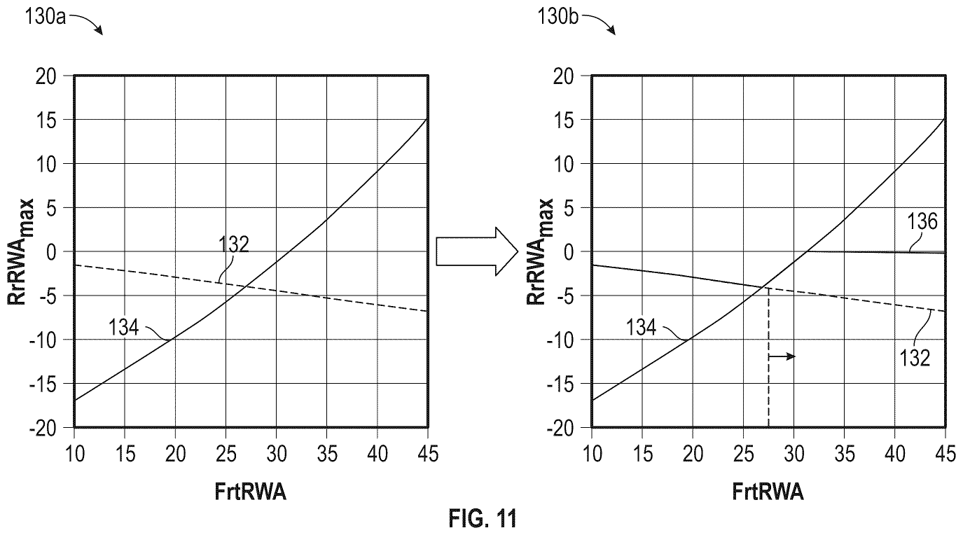

FIG. 11 depicts an example of a process of limiting or controlling a rear steering system. The rear steering system is referred to as an ARS system; however, this designation is not intended to limit the rear steering system to any specific configuration.

In this example, graphs 130a and 130b relate front wheel angle and rear wheel angle, and each show a baseline ARS curve 132 that prescribes a maximum RrRWA (in degrees) as a function of front steering angle FrRWA (in degrees). An ARS limit curve 134 was calculated as discussed above. As can be seen, the limit curve is below the baseline curve up to a front wheel angle of about 28 degrees. A resulting ARS curve 136 is provided based on the baseline ARS curve 132 and the ARS limit curve 134.

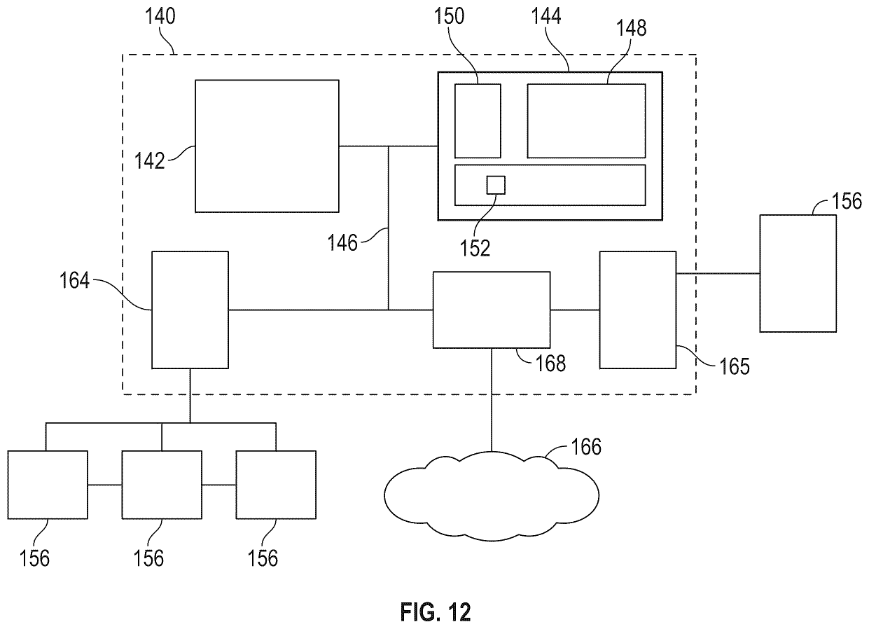

FIG. 12 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for monitoring a vehicle-trailer system, comprising:
a processing device configured to receive image data from a detection device, the image data including an image of a connection between a vehicle and a trailer being towed by the vehicle, the processing device configured to:
estimate a maximum articulation angle between the vehicle and the trailer;
analyze the image data to estimate a current articulation angle;
determine a difference between the current articulation angle and the maximum articulation angle; and
based on the current articulation angle being greater than or equal to the maximum articulation angle, or based on the current articulation angle being within a range of the maximum articulation angle, control the vehicle to avoid a jackknife condition.

2. The system of claim 1, wherein the vehicle includes a rear steering system, and the vehicle is controlled by performing at least one of turning off the rear steering system, and controlling the rear steering system to adjust a rear steering angle.

3. The system of claim 2, wherein the processing device is further configured to estimate a maximum rear steering angle based on the current articulation angle and the maximum articulation angle.

4. The system of claim 1, wherein the detection device includes a camera and the image data includes an optical image of at least a part of the connection.

5. The system of claim 4, wherein the processing device is configured to estimate the maximum articulation angle by acquiring a virtual template of the connection, estimating a dimension of the virtual template based on the image data, and rotating a component of the virtual template to estimate the maximum articulation angle.

6. The system of claim 1, wherein the processor is configured to estimate the maximum articulation angle based on one or more keypoints identified in the image data.

7. The system of claim 1, wherein the maximum articulation angle is estimated by acquiring a trailer profile and constructing a virtual template of the connection, and rotating a component of the virtual template to estimate the maximum articulation angle.

8. The system of claim 1, wherein the processing device is configured to predict an imminent jackknife condition, the predicting including analyzing the image data to locate a rear portion of the vehicle, and determining a proximity between the trailer and the rear portion.

9. A method of monitoring a vehicle-trailer system, comprising:
receiving image data from a detection device, the image data including an image of a connection between a vehicle and a trailer being towed by the vehicle;
estimating a maximum articulation angle between the vehicle and the trailer;
analyzing the image data to estimate a current articulation angle;
determining a difference between the current articulation angle and the maximum articulation angle; and
based on the current articulation angle being greater than or equal to the maximum articulation angle, or based on the current articulation angle being within a range of the maximum articulation angle, controlling the vehicle to avoid a jackknife condition.

10. The method of claim 9, wherein the vehicle includes a rear steering system, and controlling the vehicle includes at least one of turning off the rear steering system, and controlling the rear steering system to adjust a rear steering angle.

11. The method of claim 10, further comprising estimating a maximum rear steering angle based on the current articulation angle and the maximum articulation angle.

12. The method of claim 9, wherein the detection device includes a camera and the image data includes an optical image of at least a part the connection, and estimating the maximum articulation angle includes acquiring a virtual template of the connection, estimating a dimension of the virtual template based on the image data, and rotating a component of the virtual template to estimate the maximum articulation angle.

13. The method of claim 12, wherein estimating the dimension is based on one or more key points identified in the image data.

14. The method of claim 9, wherein the maximum articulation angle is estimated by acquiring a trailer profile and constructing a virtual template of the connection, and rotating a component of the virtual template to estimate the maximum articulation angle.

15. The method of claim 9, further comprising predicting an imminent jackknife condition, the predicting including analyzing the image data to locate a rear portion of the vehicle, and determining a proximity between the trailer and the rear portion.

16. A vehicle system comprising:
a detection device configured to monitor a connection between a vehicle and a trailer being towed by the vehicle, and generate data related to the connection; and
a processing device configured to receive image data from a detection device, the image data including an image of the connection, the processing device configured to:
estimate a maximum articulation angle between the vehicle and the trailer;
analyze the image data to estimate a current articulation angle;
determine a difference between the current articulation angle and the maximum articulation angle; and
based on the current articulation angle being greater than or equal to the maximum articulation angle, or being within a range of the maximum articulation angle, control the vehicle to avoid a jackknife condition.

17. The vehicle system of claim 16, wherein the vehicle includes a rear steering system, and the vehicle is controlled by performing at least one of: turning off the rear steering system, and controlling the rear steering system to adjust a rear steering angle.

18. The vehicle system of claim 17, wherein the processing device is configured to estimate a maximum rear steering angle based on the current articulation angle and the maximum articulation angle.

19. The vehicle system of claim 15, wherein the detection device includes a camera and the image data includes an optical image of at least a part the connection, and the processing device is configured to estimate the maximum articulation angle by acquiring a virtual template of the connection, estimating a dimension of the virtual template based on the image data, and rotating a component of the virtual template to estimate the maximum articulation angle.

20. The vehicle system of claim 15, wherein the maximum articulation angle is estimated by acquiring a trailer profile and constructing a virtual template of the connection, and rotating a component of the virtual template.
